(19) United States
(12) Patent Application Publication
(10) Pub. No.: US 2025/0066200 A1
(43) Pub. Date: Feb. 27, 2025

(54) APPARATUS AND METHOD FOR PRODUCING FULLERENE

(71) Applicant: MITSUBISHI CORPORATION, Tokyo (JP)

(72) Inventors: Tadashi IINO, Tokyo (JP); Tingting ZHOU, Tokyo (JP); Miyuki TOMITA, Tokyo (JP)

(73) Assignee: MITSUBISHI CORPORATION, Tokyo (JP)

(21) Appl. No.: 18/724,473

(22) PCT Filed: Dec. 22, 2022
(86) PCT No.: PCT/JP2022/047429

§ 371 Date: Aug. 19, 2024

(30) Foreign Application Priority Data
Dec. 28, 2021 (JP) 2021-214242

(51) Int. Cl. C01B 32/154

(52) U.S. Cl. CPC C01B 32/154

(57) ABSTRACT

An apparatus including: a reaction furnace (2) in which a fullerene is generated by incomplete combustion of a source material gas containing a hydrocarbon; a first injection part (9) which is disposed on an upstream end side of the reaction furnace (2) and causes the source material gas to incompletely combust while injecting the source material gas and a first oxygen-containing gas toward a downstream end side of the reaction furnace (2); and a second injection part (25a) which is disposed on the upstream end side of the reaction furnace (2) to surround the first injection part (9) and injects a second oxygen-containing gas or an inert gas toward the downstream end side of the reaction furnace (2) along a side wall (2a) of the reaction furnace (2) between the upstream end side and the downstream end side.

### TECHNICAL FIELD

The present invention relates to an apparatus and a method for producing a fullerene.

Priority is claimed on Japanese Patent Application No. 2021-214242, filed Dec. 28, 2021, the content of which is incorporated herein by reference.

### BACKGROUND ART

As a method for producing a fullerene, a combustion method in which a fullerene is generated by incomplete combustion of a source material gas containing a hydrocarbon (hereinafter also referred to as a “source material gas”) in a reaction furnace is known (see, for example, Patent Document 1). In this combustion method, a fullerene contained in soot-like material generated by incomplete combustion of a source material gas can be produced in large quantities at low cost.

### CITATION LIST

### Patent Document

Patent Document 1

Japanese Unexamined Patent Application, First Publication No. 2003-192318

### SUMMARY OF INVENTION

### Technical Problem

However, when fullerenes are continuously produced by the combustion method, some of the soot-like material generated in a reaction furnace adheres to a wall of the reaction furnace and remains in the reaction furnace. The thickness of the soot-like material that has adhered becomes thicker as the operation time of a fullerene production apparatus increases. When the thick soot-like material clogs a flow path which is provided at a space between a source material supply means and a discharging port in the reaction furnace, the incomplete combustion of the source material may not continue.

Therefore, in a case where fullerenes are continuously produced by the combustion method, it is necessary to periodically stop the operation of the fullerene production apparatus and perform maintenance work to remove the soot-like material that has adhered to the wall of the reaction furnace. As the maintenance work, for example, work in which waiting is performed until the temperature inside the reaction furnace of the production apparatus of which the operation has been stopped drops to room temperature, the reaction furnace is then opened, and the soot-like material that has adhered to the wall of the reaction furnace is removed by a physical means is performed. Such maintenance work requires a lot of time and effort.

The present invention has been proposed in consideration of such circumstances in the related art, and an object of the present invention is to provide an apparatus and a method for producing a fullerene that can improve the efficiency of fullerene production by suppressing adhesion of soot-like material, that is generated in a reaction furnace, to a wall of the reaction furnace, or by allowing easy removal of the soot-like material that has adhered to the wall of the reaction furnace.

### Solution to Problem

A first aspect of the present invention provides the following apparatus for producing a fullerene.

(1) An apparatus for producing a fullerene, including:
a reaction furnace in which a fullerene is generated by incomplete combustion of a source material gas containing a hydrocarbon;
a first injection part which is disposed on an upstream end side of the reaction furnace and causes the source material gas to incompletely combust in the reaction furnace by injecting the source material gas and a first oxygen-containing gas toward a downstream end side of the reaction furnace; and
a second injection part which is disposed on the upstream end side of the reaction furnace to surround the first injection part and injects a second oxygen-containing gas or an inert gas toward the downstream end side of the reaction furnace along a side wall of the reaction furnace which is located between the upstream end side and the downstream end side.

The apparatus for producing a fullerene according to the first aspect of the present invention preferably has the following features [2] to [11]. It is also preferable to combine two or more of the following features.

(2) The apparatus for producing a fullerene according to the above (1), wherein, when the reaction furnace is viewed in a vertical cross section in a direction from the upstream end side toward the downstream end side, a distal end of the second injection part is located in the same cross section of the reaction furnace as a distal end of the first injection part, or the distal end of the second injection part is located at an upstream side from the distal end of the first injection part.
(3) The apparatus for producing a fullerene according to the above (2),
wherein a side wall of the reaction furnace is cylindrical,
the second injection part has a second injection port portion of which a distal end surface has a ring shape, and
when a radial thickness dimension of the distal end surface of the second injection port portion is di and an inner radius of the reaction furnace is D, d₁/D is 0.01 to 0.40.
   (4) The apparatus for producing a fullerene according to the above (3), wherein, when a radial distance between an outer circumference of the distal end surface of the second injection port portion and an inner side of the side wall of the reaction furnace is d₂, d₂/D is 0.00 to 0.10.
   (5) The apparatus for producing a fullerene according to the above (3) or (4), wherein the first injection part has a cylindrical first injection port portion, a distal end surface of the first injection port portion is provided with a first injection port, and when a radius of the first injection port portion is d₃, d₃/D is 0.40 to 0.96.
   (6) The apparatus for producing a fullerene according to the above (5), wherein, when a radial distance between an outer circumference of the first injection port portion and an inner circumference of the distal end surface of the second injection port portion is d₄, d₄/D is 0.01 to 0.25.
   (7) The apparatus for producing a fullerene according to any one of the above (3) to (6),
wherein the distal end surface having a ring shape of the second injection port portion is provided with a plurality of second injection ports, each of which has a diameter of 0.1 mm to 5.0 mm,
the second injection ports are uniformly disposed on the distal end surface of the second injection port portion, and
a ratio of the total opening area of the second injection ports to an area of the distal end surface of the second injection port portion is 10% to 95%.
   (8) The apparatus for producing a fullerene according to any one of the above (3) to (7), wherein the second injection port portion is made of a porous body.
   (9) The apparatus for producing a fullerene according to any one of the above (3) to (6), wherein a second injection port of the second injection port portion is a ring-shaped slit in a plan view.
   (10) The apparatus for producing a fullerene according to any one of the above (3) to (9), wherein a flow rate of the second oxygen-containing gas or the inert gas which is injected from the second injection part is 0.1 to 10.0 NL/min per 1 cm² of an area of the distal end surface of the second injection port portion.
   (11) The apparatus for producing a fullerene according to any one of the above (1) to (10),
wherein the upstream end side of the reaction furnace is provided with a cylindrical porous body to cover or bury a distal end of the first injection part and a distal end of the second injection part, and
in a direction from the upstream end side toward the downstream end side, a thickness of the porous body from the distal end located on a downstream side of each of the first injection part and the second injection part to a distal end located on a downstream side of the cylindrical porous body, is 1 to 50 mm.

A second aspect of the present invention provides the following method for producing a fullerene.

(12) A method for producing a fullerene, including a fullerene generation step of generating soot-like material containing a fullerene in a reaction furnace by incomplete combustion of a source material gas containing a hydrocarbon,
wherein, in the fullerene generation step,
while the source material gas and a first oxygen-containing gas are injected from a first injection part disposed at an upstream end side of the reaction furnace toward a downstream end side thereof, the source material gas is incompletely combusted in the reaction furnace, and
a second oxygen-containing gas or an inert gas is injected from a second injection part, which is disposed at the upstream end side to surround the first injection part, toward the downstream end side along a side wall of the reaction furnace which is located between the upstream end side and the downstream end side.

A third aspect of the present invention provides the following method for producing a fullerene.

(13) A method for producing a fullerene, including:
a fullerene generation step in which, while a source material gas containing a hydrocarbon and a first oxygen-containing gas are injected from a first injection part, which is disposed at an upstream end side of a reaction furnace, toward a downstream end side thereof, the source material gas is incompletely combusted to generate soot-like material containing a fullerene; and
a soot-like material removal step in which, after the fullerene generation step, a second oxygen-containing gas or an inert gas is injected from a second injection part, which is disposed at the upstream end side of the reaction furnace to surround the first injection part, toward the downstream end side along a side wall of the reaction furnace, which is located between the upstream end side and the downstream end side, to remove the soot-like material that has adhered to the side wall of the reaction furnace.

### Advantageous Effects of Invention

As described above, according to the present invention, it is possible to improve the efficiency of fullerene production by suppressing adhesion of the soot-like material generated in a reaction furnace from adhering to a wall of the reaction furnace, or by easily removing the soot-like material that has adhered to the wall of the reaction furnace.

### BRIEF DESCRIPTION OF DRAWINGS

FIG. 1 is a configuration diagram showing an example of a fullerene production apparatus 1 according to one embodiment of the present invention.

FIG. 2 is a schematic vertical cross-sectional view showing a configuration of a reaction furnace 2 equipped with a burner 9 and a gas introduction part 10 according to one embodiment of the present invention.

FIG. 3 is a schematic diagram illustrating the burner 9, a second injection part 25a, and a side wall 2a, which are observed when the reaction furnace 2 is cut along a dashed line A-A in FIG. 2 and seen from the cross section in a direction toward an upper wall portion 2b.

FIG. 4 is a schematic vertical cross-sectional view showing a configuration of a reaction furnace 2 equipped with a burner 9 and a gas introduction part 10 according to one embodiment of the present invention.

FIG. 5 is a schematic diagram illustrating the burner 9, a second injection part 25a, and a side wall 2a, which are observed when the reaction furnace 2 is cut along a dashed line A-A in FIG. 4 and seen from the cross section in a direction toward an upper wall portion 2b.

FIG. 6 is a schematic vertical cross-sectional view showing a configuration of a reaction furnace 2 equipped with a porous body 28.

### DESCRIPTION OF EMBODIMENTS

Hereinafter, preferred examples of an apparatus and a method for producing a fullerene to which the present invention is applied will be described in detail with reference to the drawings.

The present invention is not limited only to embodiments which will be described below. In the present invention, for example, numbers, shapes, types, positions, amounts, ratios, materials, members, configurations, or the like may be added, omitted, replaced, or changed without departing from the gist of the present invention. In the drawings which will be used in the following description, featured portions may be shown schematically for convenience in order to make the features easy to understand, and the dimensions and the ratios of constituent elements are not always the same as the actual ones.

### Apparatus for Producing Fullerene

The apparatus for producing a fullerene of the present embodiment generates a fullerene by incomplete combustion of a source material containing a hydrocarbon. Examples of the fullerene that is generated include higher fullerenes such as C₆₀ fullerene (C₆₀), C₇₀ fullerene (C₇₀), C₇₆, C₇₈, C₈₄, C₉₀, and C₉₆. The incomplete combustion means that a substance (for example, the source material described above or the like) burns in a state in which there is insufficient oxygen.

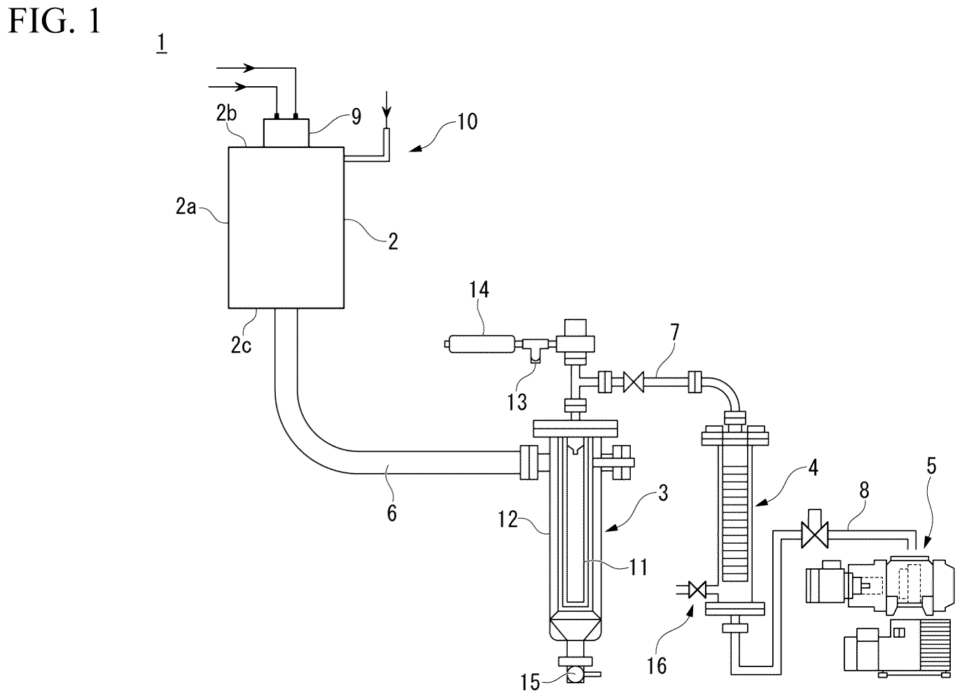

FIG. 1 is a configuration diagram showing a preferred example of a fullerene production apparatus 1. The fullerene production apparatus 1 includes a reaction furnace 2 in which soot-like material containing a fullerene is generated by incomplete combustion of a source material gas containing a hydrocarbon, a recovery mechanism 3 that recovers the soot-like material generated in the reaction furnace 2, a cooling mechanism 4 that cools a gas that has passed through the recovery mechanism 3, and a pressure reduction mechanism 5 that brings the inside of the reaction furnace 2 into a reduced pressure state while suctioning the gas that has been cooled by the cooling mechanism 4. The mechanisms may refer to an apparatus or an instrument.

In addition, this fullerene production apparatus 1 has a first pipe 6 that connects the reaction furnace 2 and the recovery mechanism 3 to each other, a second pipe 7 that connects the recovery mechanism 3 and the cooling mechanism 4 to each other, and a third pipe 8 that connects the cooling mechanism 4 and the pressure reduction mechanism 5 to each other.

The reaction furnace 2 has a cylindrical side wall 2a, an upper wall portion 2b that closes the upper end (the upstream end side) of the side wall 2a, and a lower wall portion 2c that closes the lower end side (the downstream end side) of the side wall 2a, and is disposed in an upright state in a vertical direction. The transverse cross section of the reaction furnace 2 is circular, as will be described below.

The material of the reaction furnace 2 can be selected arbitrarily, and examples of the material include heat-resistant materials such as zirconia (ZrO₂), tungsten (W), tantalum (Ta), platinum (Pt), titanium (Ti), titanium nitride (TiN), alumina (Al₂O₃), and silicon carbide (SiC). In addition, at least a portion of the outer and inner sides of the reaction furnace may be lined with a heat insulating material such as an alumina refractory brick or an alumina monolithic refractory material.

In addition, as for the arrangement of the reaction furnace 2, it is preferable to arrange the reaction furnace 2 in the vertical direction as described above, because this reduces the influence of the retention of the soot-like material. In a case where the reaction furnace 2 is disposed in the vertical direction, the source material gas is preferably supplied from above. On the other hand, the reaction furnace 2 can also be disposed, for example, in a horizontal direction or in a state of being tilted in an oblique direction.

The first pipe 6 is connected to a discharging port 30d (hereinafter referred to as an “exhaust gas discharging port 30d”) provided in the lower wall portion 2c of the reaction furnace 2 for discharging an exhaust gas. On the other hand, a burner 9 that is a first injection part and a gas introduction part 10 are provided on a side of the upper wall portion 2b of the reaction furnace 2. In the first injection part, as will be described below, a source material gas and a first oxygen-containing gas are injected (it may be referred to as injection I). In the reaction furnace 2, the source material gas and the first oxygen-containing gas, which are injected from a pipe provided at the first injection part (the burner 9), are incompletely combusted in the reaction furnace 2 to generate the soot-like material containing the fullerene.

Further, in addition to the gas injection described above, a second oxygen-containing gas or an inert gas is injected from the gas introduction part 10 in the reaction furnace 2 along the side wall 2a (it may be referred to as injection II). This makes it possible to prevent adhesion of the soot-like material to the side wall 2a and/or to remove the soot-like material, which has adhered to the side wall 2a, from the side wall 2a.

The high-temperature exhaust gas, which contains the soot-like material generated by incomplete combustion of the source material gas and the first oxygen-containing gas, carbon monoxide, carbon dioxide, water vapor, the second oxygen-containing gas, the inert gas, and the like, passes through the first pipe 6 and reaches the recovery mechanism 3.

The recovery mechanism 3 has a collector 12 in which a filter 11 is housed, a tank 14 that is connected to the upper end (one end) side of the collector 12 via an electromagnetic valve 13, and a discharge valve 15 provided on the lower end (the other end) side of the collector 12.

As shown in FIG. 1, the first pipe 6 is connected to the side surface of the upper portion side of the collector 12. The second pipe 7 is connected to the upper portion of the collector 12. The second pipe 7 is provided with a valve. For example, a sintered metal filter is used as the filter 11. The electromagnetic valve 13 is connected to a branch of the second pipe 7. A high-pressure inert gas such as nitrogen gas (N₂) or argon gas (Ar) is stored in the tank 14.

In the recovery mechanism 3, the soot-like material contained in the exhaust gas that is supplied from the first pipe 6 is collected by the filter 11. After the soot-like material is collected, the electromagnetic valve 13 is periodically opened to inject the inert gas from the tank 14 toward the collector 12. This injection causes the soot-like material that has adhered to the filter 11 to fall off. Thereafter, the discharge valve 15 is opened, and thus the soot-like material accumulated in the collector 12 can be recovered via the discharge valve 15.

The cooling mechanism 4 has a structure that is the same as or similar to that of a normal heat exchanger. In the cooling mechanism 4, one end (an upper end) side thereof is connected to the second pipe 7, and the other end (the lower end) side thereof is connected to the third pipe 8.

In the cooling mechanism 4, the gas that has passed through the recovery mechanism 3 is cooled. Furthermore, in the cooling mechanism 4, it is possible to liquefy water vapor and the unreacted hydrocarbon in the gas and to discharge them from a drain 16 provided on the lower portion side thereof.

In addition to the cooling mechanism 4, the first pipe 6 may be configured to be cooled because the exhaust gas passing through the first pipe 6 has a high temperature.

The pressure reduction mechanism 5 is preferably a vacuum pump and suctions the gas, which is cooled by the cooling mechanism 4, through the third pipe 8. Such suction allows the soot-like material, which is generated in the reaction furnace 2, to be discharged through the first pipe 6 to a side of the recovery mechanism 3, while generating a negative pressure between the pressure reduction mechanism 5 and the reaction furnace 2.

Examples of the hydrocarbon which is contained in the source material gas used for generating a fullerene include an aromatic hydrocarbon having a carbon number of 6 to 15 such as toluene, benzene, xylene, naphthalene, methylnaphthalene, anthracene, and phenanthrene; a coal-based hydrocarbon such as creosote oil or carboxylic acid oil; an ethylene-based unsaturated hydrocarbon; an acetylene-based unsaturated hydrocarbon; an aliphatic saturated hydrocarbon such as pentane or hexane; and the like. In addition, these hydrocarbons may be used alone or in combination of two or more. Of the hydrocarbons described above, the aromatic hydrocarbon is preferably contained in the source material gas. The source material gas may be diluted with an inert gas such as nitrogen or argon, if necessary. The proportion of the hydrocarbon contained in the source material gas may be selected arbitrarily, if necessary. It is sufficient that the hydrocarbon is in a state of a source material gas, before entering the first injection part 9 or a burner holder 23. Prior to entering the first injection part, the hydrocarbon may be in a liquid state.

In addition, the first oxygen-containing gas and the second oxygen-containing gas are gases containing oxygen gas, and examples of the oxygen-containing gas include oxygen gas, air, and the like. The proportion of the oxygen contained in the oxygen-containing gas may be selected arbitrarily, if necessary. The first oxygen-containing gas and the second oxygen-containing gas can be the same or different. The first oxygen-containing gas used for producing a fullerene may be supplied to the reaction furnace 2 separately from the source material gas, or may be mixed with the source material gas in advance and then supplied to the reaction furnace 2.

In the reaction furnace 2, in injection II, an inert gas not containing oxygen gas may be supplied instead of the second oxygen-containing gas described above. Here, the inert gas is not particularly limited as long as it does not react with the generated soot-like material, the exhaust gas, and the like. Examples of the inert gas include nitrogen gas, argon gas, carbon dioxide, and the like.

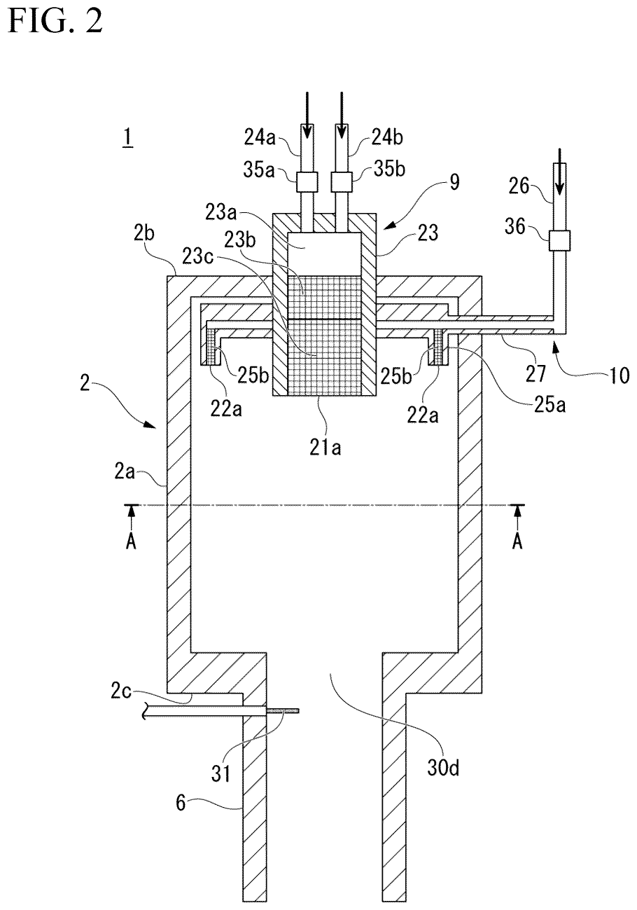

Next, specific configurations of the burner 9 (the first injection part) and the gas introduction part 10 included in the fullerene production apparatus 1 will be described with reference to FIGS. 2 to 5.

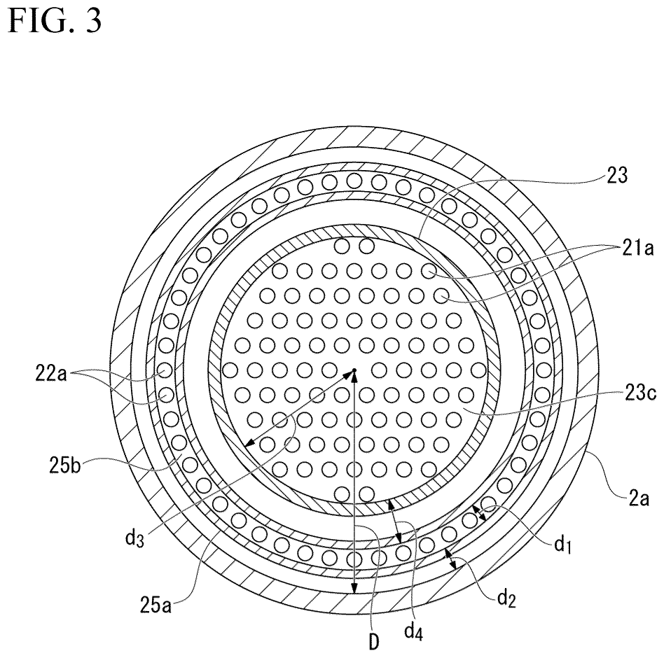

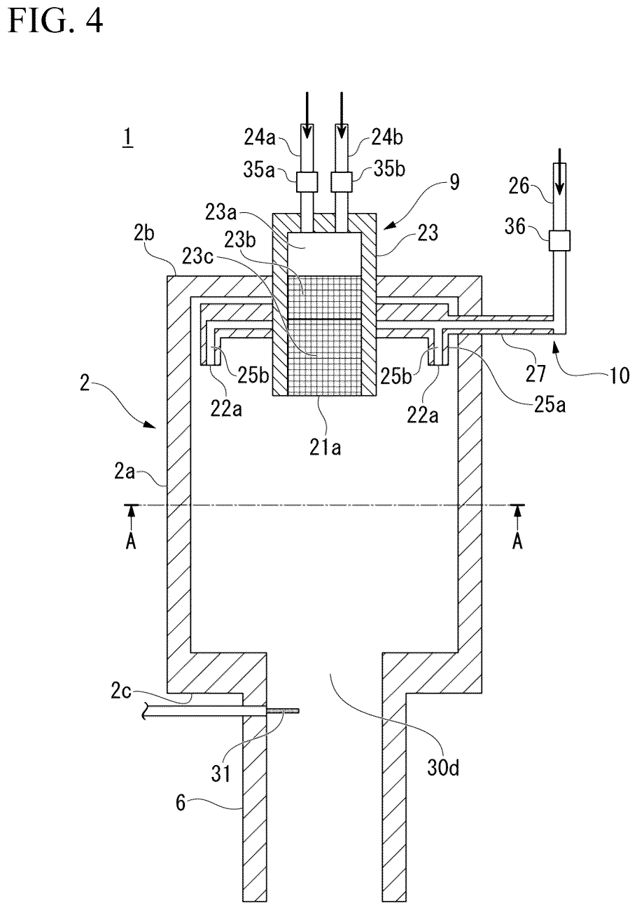

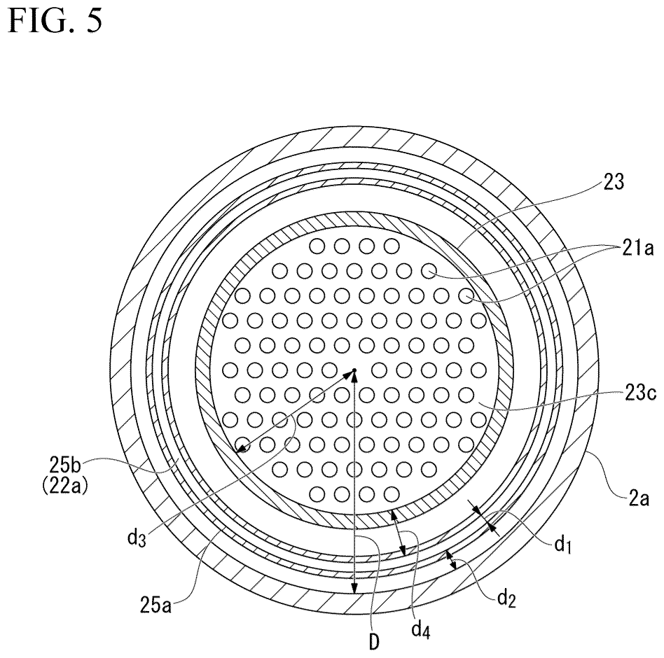

FIGS. 2 and 4 are vertical cross-sectional views showing examples of a configuration of the reaction furnace 2 equipped with the burner 9 and the gas introduction part 10. FIGS. 3 and 5 are diagrams illustrating the burner 9, a second injection part 25a which will be described below, the side wall 2a, and the like, which are obtained when the reaction furnace 2 is cut along a dashed line A-A in each of FIGS. 2 and 4 and seen in a direction toward the upper wall portion 2b from the cross section.

The fullerene production apparatus 1 of the present embodiment includes the burner 9 and the gas introduction part 10 as shown in FIG. 2, for example. The burner 9 performs the supply of the gases which are used in the production of a fullerene (injection I). The gas introduction part 10 supplies the gas which is used to prevent adhesion of the soot-like material to the side surface of the furnace wall or to remove the soot-like material that has adhered thereto (injection II).

The burner 9 that is the first injection part has a cylindrical burner holder 23 with a top wherein the holder is attached to the reaction furnace 2 in a state that it is passing through the upper wall portion 2b of the reaction furnace 2. A part of the burner holder 23 protrudes into the reaction furnace 2. The burner holder 23 preferably has a premixing chamber 23a, a pressure accumulation chamber 23b, and a cylindrical first injection port portion 23c in the inside thereof, which are provided in this order from the top. Furthermore, a pipe 24a for introducing the source material gas and a pipe 24b for introducing the first oxygen-containing gas are connected to the upper portion of the burner holder 23 via a flashback prevention device (not shown).

The pipe 24a is preferably provided with a first flow meter 35a for controlling the flow rate of the source material gas (or the liquid hydrocarbon). In addition, in a case in which the liquid hydrocarbon are used, a gasification device such as a heating device that gasifies the liquid hydrocarbon may be provided in the pipe 24a between the first flow meter 35a and the upper portion of the burner holder 23.

The pipe 24b is provided with a first flow meter 35b for controlling the flow rate of the first oxygen-containing gas. A flow rate adjustment part has the first flow meters 35a and 35b. The flow rate adjustment part uses the first flow meters 35a and 35b to adjust the ratio A1 of the number of carbon atoms of the source material gas to the number of oxygen atoms of the first oxygen-containing gas (the number of carbon atoms of the source material gas/the number of oxygen atoms of the first oxygen-containing gas) into 0.60 to 2.00, and can supply the source material gas and the first oxygen-containing gas to the first injection port portion 23c within a preferred range.

The first flow meters 35a and 35b only have to be capable of adjusting the flow rates of the source material gas (or the liquid hydrocarbon) and the first oxygen-containing gas to predetermined values, and, for example, a commercially available mass flow controller or the like can be used as the flow meter.

In the premixing chamber 23a, the source material gas introduced from the pipe 24a and the first oxygen-containing gas introduced from the pipe 24b are uniformly mixed.

The pressure accumulation chamber 23b accumulates the source material gas and the first oxygen-containing gas mixed in the premixing chamber 23a (hereinafter also referred to as a “mixed gas”) at a predetermined pressure.

The first injection port portion 23c has one or more first injection ports 21a. The first injection port portion 23c may have, for example, a cylindrical shape. The mixed gas accumulated in the pressure accumulation chamber 23b is injected from the first injection port 21a toward the lower wall portion 2c (injection I). It is preferable that the first injection port portion 23c is provided with a large number of first injection ports 21a gathered together. Examples of the first injection port portion 23c include a portion provided with a large number of first injection ports 21a each having a diameter of 0.1 mm to 5.0 mm and a substantially circular shape in a plan view. A plurality of injection ports 21a may be selected arbitrarily, may be disposed randomly, or may be disposed regularly. The injection port 21a may be provided by a hole of a porous body, may be an opening of a recess obtained by processing the surface of the porous body, or may be an opening located at the lower portion of a through hole extending in a vertical direction which is obtained by processing the porous body. Examples thereof include a porous ceramic sintered body, a porous body produced by a 3D printer, an injection port with a plurality of through holes produced by post-processing, and the like.

In a case in which the first injection port portion 23c is provided with a large number of first injection ports 21a gathered together, the ratio of the total opening area of the first injection ports 21a to the area (the total area) of the distal end surface of the first injection port portion 23c is preferably 10% to 95% and more preferably 50% to 95%. As the first injection port portion 23c, for example, a porous body having a plurality of first injection ports 21a which is made of a porous ceramic sintered body, a sintered body of metal powder, or the like can be used.

When the radius of the first injection port portion 23c is shown as da and the inner radius of the reaction furnace 2 is shown as D, d₃/D is preferably 0.40 to 0.96, more preferably 0.50 to 0.95, and even more preferably 0.60 to 0.94. Within this range, the soot-like material containing a fullerene can be efficiently generated. The ratio may be 0.63 to 0.90, 0.64 to 0.85, 0.65 to 0.80, 0.66 to 0.75, 0.67 to 0.70, or the like.

In addition, in the present embodiment, the premixing chamber 23a, the pressure accumulation chamber 23b, and the first injection port portion 23c are provided inside the burner holder 23, but the premixing chamber 23a may be omitted. Furthermore, the premixing chamber 23a and the pressure accumulation chamber 23b may be provided outside the burner holder 23, if necessary.

As shown in FIG. 2, the gas introduction part 10 has a cylindrical second injection part 25a surrounding the first injection part (the burner 9) and a connection pipe 27 connected to the second injection part 25a. The second injection part 25a injects the gas to prevent the deposition or adhesion of the soot-like material to the furnace wall and to remove the soot-like material that has adhered to or deposited on the inner wall (injection II).

Furthermore, the distal end of the second injection part 25a is located on the same cross section (the same height position) as the distal end of the first injection part (the burner 9) in a direction from a side of the upper wall portion 2b (an upstream end side) toward a side of the lower wall portion 2c (a downstream end side) of the reaction furnace 2 when viewed in a vertical cross section passing through the center of the reaction furnace 2, in other words, the distal end of the first injection part and the distal end of the second injection part 25a are located side by side in the horizontal direction, or the distal end of the second injection part 25a is located on a more upstream side (a side closer to the upper wall portion 2b) than the distal end of the first injection part (the burner 9). With such a structure, the adhesion of the soot-like material to the periphery of the burner holder 23 can be effectively suppressed.

The second injection part 25a has a second injection port portion 25b of which a distal end surface has a ring shape in a plan view. The second injection part 25a may have cylindrical outer and inner walls that are concentrically disposed. A space between the outer wall and the inner wall may have a shape that is selected arbitrarily, and a member having a shape and a material that are selected arbitrarily may be inserted into the space between the outer wall and the inner wall. The side wall of the reaction furnace or a part thereof may serve as the cylindrical outer wall. The side wall of the reaction furnace, the side wall of the second injection part 25a, and the side wall of the burner 9 may be disposed concentrically. When the radial thickness dimension of the distal end surface (the width of an opening) of the second injection port portion 25b is shown as di, the ratio of the radial thickness dimension di to the inner radius D of the reaction furnace 2, that is, d₁/D, is preferably 0.01 to 0.40, more preferably 0.01 to 0.30, and even more preferably 0.01 to 0.20. Within this range, adhesion of the soot-like material can be prevented and the effect on fullerene generation is small. The ratio may be 0.03 to 0.25, 0.05 to 0.18, 0.07 to 0.15, 0.10 to 0.13, or the like.

The shape, material, and configuration of the second injection port portion 25b provided in the second injection part 25a can be selected arbitrarily. For example, it may be in a doughnut shape in a plan view. The gas flows through the second injection port portion 25b. It is preferable that the second injection port portion 25b has, for example, a structure in which a large number of second injection ports 22a gathered together are provided on the distal end surface thereof as shown in FIG. 3. Examples of the configuration of the second injection port portion 25b include a configuration in which a large number of second injection ports 22a, which are substantially circular in a plan view and have a diameter of 0.1 mm to 5.0 mm, are uniformly provided on the distal end surface (in the present example, the distal end surface having a ring shape) of the second injection part 25a. In a case in which the second injection port portion 25b has a shape or structure in which a large number of second injection ports 22a gathered together are provided, the ratio of the total opening area of the second injection ports 22a to the area of the distal end surface of the second injection port portion 25b, that is, the area of the distal end surface of the second injection part 25a, is preferably 10% to 95%, and more preferably 50% to 95%. In a case in which the second injection port 22a has a plurality of openings, the arrangement of the openings can be selected arbitrarily, and the openings may be disposed randomly or may be disposed side by side at equal intervals. As a specific example of the second injection port portion 25b, for example, a porous body having a plurality of second injection ports 22a which is made of a porous ceramic sintered body, a sintered body of metal powder, or the like can be used. In this case, d₁/D is more preferably 0.05 to 0.20.

The shape of the distal end surface of the second injection port portion 25b may be, for example, a ring-shaped slit (a ring-shaped opening) as shown in FIG. 5. That is, the second injection port portion 25b may be a hollow fluidic channel. The second injection port 22a of the second injection port portion 25b shown in FIG. 5 is a ring-shaped slit provided in the distal end surfaces of the second injection part 25a. In this case, d₁/D is more preferably 0.01 to 0.15, and particularly preferably 0.01 to 0.10.

The second oxygen-containing gas or the inert gas is injected from the second injection port 22a of the second injection port portion 25b toward a side of the lower wall portion 2c (the downstream end side) of the reaction furnace 2 along the side wall 2a (injection II).

When a radial distance between the outer circumference of the ring-shaped opening (the outer circumference of the ring-shaped opening) at the distal end surface of the second injection port portion 25b and the inner side (the inner surface) of the side wall 2a of the reaction furnace 2 is shown as d₂, the ratio of the radial distance to the inner radius D of the reaction furnace 2, that is, d₂/D, is preferably 0.00 to 0.10, more preferably 0.00 to 0.07, and even more preferably 0.00 to 0.05. Within this range, the effect of preventing adhesion of the soot-like material to the side wall 2a or removing the soot-like material that has adhered thereto is improved. The ratio may be, for example, 0.00 to 0.04, 0.01 to 0.03, or 0.02 to 0.03.

From the viewpoint of miniaturizing the reaction furnace 2, when a radial distance between the first injection port portion 23c and the inner circumference of the ring-shaped distal end surface of the second injection port portion 25b (the inner circumference of the ring-shaped opening) is shown as d₄, the ratio of the radial distance to the inner radius D of the reaction furnace 2, that is, d₄/D, is preferably 0.01 to 0.25, and more preferably 0.01 to 0.20. The thickness of the burner holder 23 or a portion of the second injection part 25a other than the second injection port portion 25b may be appropriately selected to satisfy the above conditions. The ratio may be 0.01 to 0.23, 0.02 to 0.15, 0.03 to 0.10, 0.05 to 0.08, or the like.

A pipe 26 connected to the connection pipe 27 which is connected to the second injection part 25a is provided with a second flow meter 36 for controlling the flow rate of the second oxygen-containing gas or the inert gas. The second flow meter 36 only has to be capable of adjusting the flow rate of the second oxygen-containing gas or the inert gas to a predetermined value, for example, 0.1 to 10.0 NL/min per 1 cm² of the area of the distal end surface of the second injection port portion 25b, and, for example, a commercially available mass flow controller or the like can be used as the flow meter. Here, NL/min is normal liters/minute and represents the volume of the gas supplied per minute under standard conditions (pressure 0.1013 MPa, temperature 0° C., humidity 0%).

The connection pipe 27 passes through the upper portion of the side wall 2a of the reaction furnace 2 to supply the second oxygen-containing gas or the inert gas to the second injection part 25a. Alternatively, the connection pipe 27 may pass through the upper wall portion 2b of the reaction furnace 2 to supply the second oxygen-containing gas or the inert gas to the second injection part 25a.

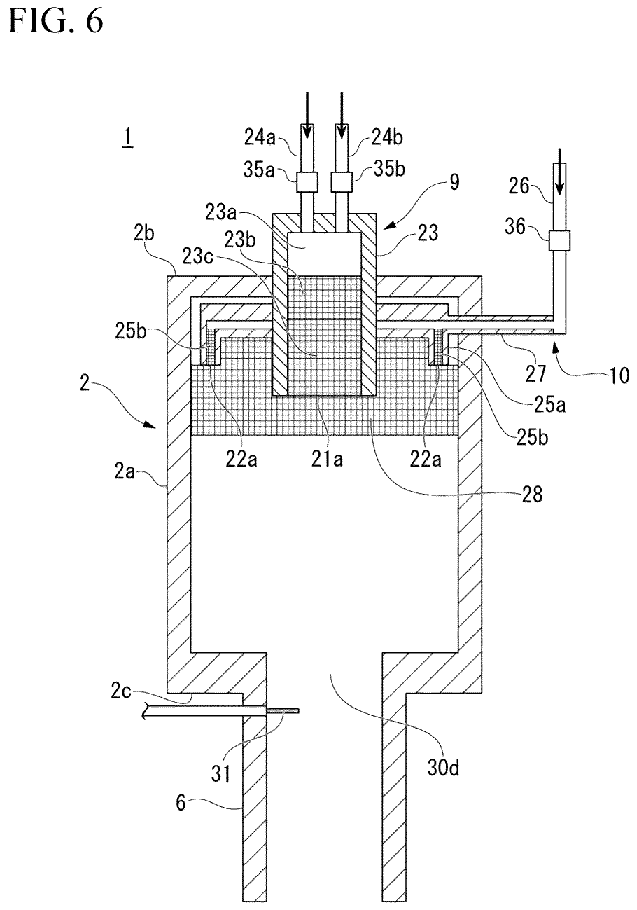

In addition, in order to equalize the flow rates of the gases, a member for covering or burying the first injection part and the second injection part 25a may be further provided in the reaction furnace 2. Specifically, as shown in FIG. 6, in order to equalize the flow rates of the mixed gas used for producing a fullerene and the second oxygen-containing gas or the inert gas used for preventing adhesion of the soot-like material or for removing the soot-like material, a cylindrical or substantially cylindrical porous body 28 may be provided on the upstream end side (the side of the upper wall portion 2b) in the reaction furnace 2 to cover or bury the distal end of the first injection part (the burner 9) and the distal end of the second injection part 25a. The outer diameter of the porous body 28 may be the same as the inner diameter of the furnace 2.

The thickness of the porous body 28 can be selected arbitrarily. For example, in a direction from the upstream end side (the side of the upper wall portion 2b) toward the downstream end side (the side of the lower wall portion 2c), the thickness of the porous body 28 from the distal end located on a downstream side of each of the first injection part (the burner 9) and the second injection part 25a to the lower surface (the downstream side surface) of the porous body 28 is preferably 1 to 50 mm and more preferably 10 to 30 mm. As the porous body, a porous body made of a porous ceramic sintered body, a sintered body of metal powder, or the like that can be used for the first injection port portion 23c is suitably used.

Further, an ignition mechanism 31 for igniting the source material gas is provided near the exhaust gas discharging port 30d of the reaction furnace 2. The position of the ignition mechanism 31 can be selected arbitrarily. In the present embodiment, the ignition mechanism 31 is provided outside the exhaust gas discharging port 30d of the reaction furnace 2, but it may be provided inside the furnace.

In the fullerene production apparatus 1 of the present embodiment which has the configuration described above and is equipped with the burner 9 and the gas introduction part 10, while the source material gas and the first oxygen-containing gas are injected into the reaction furnace 2 from the first injection port 21a of the burner 9 described above (injection I), the source material gas is incompletely combusted and the soot-like material containing a fullerene is generated in the reaction furnace 2. While the soot-like material is generated, the second oxygen-containing gas or the inert gas is injected into the reaction furnace 2 from the second injection port 22a described above (injection II). Such injection can prevent the generated soot-like material from adhering to the side wall 2a of the reaction furnace 2.

While the fullerene is generated by injection I, injection II may be performed, but the timing may be shifted as necessary. For example, in the fullerene production apparatus 1 of the present embodiment which is equipped with the burner 9 and the gas introduction part 10, after the fullerene generation step described above (executing injection I), the second oxygen-containing gas or the inert gas can also be injected along the side wall 2a of the reaction furnace 2 (executing injection II). By this method, the soot-like material that has adhered to the side wall 2a of the reaction furnace 2 can be removed from the side wall 2a.

As a result, in the fullerene production apparatus 1 of the present embodiment which is equipped with the burner 9 and the gas introduction part 10, it is possible to prevent adhesion of the soot-like material to the side wall 2a of the reaction furnace 2, or to easily remove the soot-like material that has adhered thereto, and it is possible to eliminate the need for conventional maintenance work. This makes it possible to improve the efficiency of fullerene production.

### Method for Producing Fullerene

Next, methods for producing a fullerene using the fullerene production apparatus 1 described above (a producing method of a first embodiment and a producing method of a second embodiment) will be described.

The method for producing a fullerene of the first embodiment includes a fullerene generation step in which the source material gas containing the hydrocarbon is incompletely combusted in the reaction furnace 2 to generate the soot-like material containing the fullerene. In this step, while the source material gas and the first oxygen-containing gas are injected from the first injection part, which is disposed at the upstream end side (the side of the upper wall portion 2b) of the reaction furnace 2, from the upstream end side (the side of the upper wall portion 2b) toward the downstream end side (the side of the lower wall portion 2c) of the reaction furnace 2 (injection I), the source material gas is incompletely combusted. In addition, while the incomplete combustion is performed, the second oxygen-containing gas or the inert gas is injected from the second injection part 25a, which is disposed at the upstream end side of the reaction furnace 2 to surround the first injection part, from the upstream end side toward the downstream end side of the reaction furnace 2 along the side wall 2a of the reaction furnace 2 (injection II). Injection II may be started after injection I has been started, injection I may be started after injection II has been started, or injection I and injection II may be started simultaneously.

In the method for producing a fullerene of the present embodiment, the source material gas and the first oxygen-containing gas described above are incompletely combusted to generate the soot-like material. Furthermore, the second oxygen-containing gas or the inert gas is injected from the upstream end side toward the downstream end side of the reaction furnace 2 along the side wall 2a of the reaction furnace 2. This injection can prevent the soot-like material from adhering to the side wall 2a. It is preferable to inject the second oxygen-containing gas from the viewpoint of improving the effect of preventing adhesion of the soot-like material by reacting the second oxygen-containing gas with the soot-like material that has diffused to the side wall 2a.

In this case, the flow rate of the second oxygen-containing gas or the inert gas which is injected from the second injection port portion 25b is preferably 0.1 to 10.0 NL/min, and more preferably 0.1 to 7.0 NL/min per 1 cm² of the area of the distal end surface of the second injection port portion 25b. Within this range, the fullerene can be produced without decreasing the yield.

In addition, in the method for producing a fullerene of the present embodiment, after the fullerene generation step described above, the second oxygen-containing gas or the inert gas may be injected along the side wall 2a of the reaction furnace 2 (a soot-like material removal step). For example, in the soot-like material removal step, all the gas supplies which are performed for injection I and injection II may be stopped once, and then the gas for injection II may be injected. Alternatively, only the gas supply for injection I may be stopped, while the gas supply for injection Il may be continued without being stopped. This makes it possible to remove the soot-like material, that has adhered to the side wall 2a, from the side wall 2a. In this case, the flow rate of the second oxygen-containing gas or the inert gas which is injected from the second injection port portion 25b is preferably 0.1 to 10.0 NL/min, and more preferably 0.5 to 10.0 NL/min per 1 cm² of the area of the distal end surface of the second injection port portion 25b. Within this range, the soot-like material that has adhered to the side wall 2a can be sufficiently removed. In addition, since the inert gas does not react with the soot-like material that has adhered to the side wall 2a and the fullerene in the soot-like material that has adhered to the side wall 2a can also be recovered to the maximum extent, it is preferable to inject the inert gas after the fullerene generation step.

The method for producing a fullerene of the second embodiment includes a fullerene generation step in which, while the source material gas containing a hydrocarbon and the first oxygen-containing gas are injected from the first injection part, which is disposed at the upstream end side (the side of the upper wall portion 2b) of the reaction furnace 2, toward the downstream end side (the side of the lower wall portion 2c), the source material gas is incompletely combusted to generate the soot-like material containing a fullerene. In addition, after the fullerene generation step, a soot-like material removal step is included. In the soot-like material removal step, the second oxygen-containing gas or the inert gas is injected from the second injection part 25a, which is disposed at the upstream end side of the reaction furnace 2 to surround the first injection part, toward the downstream end side along the side wall 2a to remove the soot-like material that has adhered to the side wall 2a.

In the method for producing a fullerene of the second embodiment, the soot-like material removal step is performed before the fluidic channel in the reaction furnace 2 is clogged with the soot-like material that has adhered to the side wall 2a. It is preferable that the fullerene generation step and the soot-like material removal step be alternately repeated. The number of repetitions can be selected arbitrarily and may be, for example, 1 to 30 times, 2 to 10 times, 3 to 6 times, or the like. In this case, the flow rate of the second oxygen-containing gas or the inert gas which is injected from the second injection port portion 25b is preferably 0.1 to 10.0 NL/min, and more preferably 0.5 to 10.0 NL/min per 1 cm² of the area of the distal end surface of the second injection port portion 25b. In addition, since the inert gas does not react with the soot-like material that has adhered to the side wall 2a and the fullerene in the soot-like material that has adhered to the side wall 2a is also recovered to the maximum extent, it is preferable to inject the inert gas in the soot-like material removal step. In these steps, it is preferable to perform the soot-like material removal step (injection II), after stopping all the gas supplies (injection I) used in the fullerene generation step.

In the methods for producing a fullerene of the first and second embodiments, the flow rate of the source material gas that is supplied to the first injection part only has to be adjusted according to the dimensions of the reaction furnace 2 and the first injection port portion 23c. The flow rate of the first oxygen-containing gas is adjusted according to the type and the flow rate of the source material gas. The ratio of the number of carbon atoms in the source material gas to the number of oxygen atoms in the first oxygen-containing gas, that are supplied to the first injection part per 1 minute, is preferably 0.60 to 2.00, more preferably 0.60 to 1.60, and even more preferably 0.80 to 1.40. When the above ratio is within the above range, the yield of a fullerene becomes high.

The pressure inside the reaction furnace 2 can be selected arbitrarily and is preferably 1 to 30 kPa and more preferably 1 to 10 kPa. When the pressure inside the reaction furnace 2 is 1 kPa or more, the load on the pressure reduction mechanism 5 does not become large. On the other hand, when the pressure inside the reaction furnace 2 does not exceed 30 kPa, the flame will not flash back.

In the fullerene generation step, the temperature inside the reaction furnace 2 during incomplete combustion of the source material gas can be selected arbitrarily and is preferably 1000°° C. to 2000° C. and more preferably 1300° C. to 1900° C. When the temperature inside the reaction furnace 2 is 1000° C. or higher, the soot-like material containing a fullerene is generated efficiently, and the yield of a fullerene is improved. When the temperature inside the reaction furnace 2 is 2000° C. or less, a large amount of energy is not required to increase the temperature inside the reaction furnace 2, and the fullerene can be produced efficiently. The temperature inside the reaction furnace 2 can be measured by an ultra-high temperature thermocouple or the like.

Therefore, in the method for producing a fullerene of the present embodiment, it is possible to suppress adhesion of the soot-like material to the side wall 2a of the reaction furnace 2, or to easily remove the soot-like material that has adhered thereto, and thus it is possible to eliminate the need for conventional maintenance work and to improve the efficiency of fullerene production.

The length of time required for the fullerene generation step and the treatment time required for the soot-like material removal step can be selected arbitrarily. The time required for the fullerene generation step may be, for example, 60 to 20,000 minutes, or 360 to 10,000 minutes. The time required for the soot-like material removal step may be, for example, 30 to 5000 minutes, or 60 to 1,440 minutes.

The producing methods of the above embodiments may include a recovery step of recovering the generated soot-like material, a cooling step of cooling the gas in which the recovered soot-like material is included, and a pressure reduction step of making the cooled gas into a reduced pressure state.

The present invention is not necessarily limited to the embodiments described above, and various modifications can be made without departing from the spirit of the present invention.

### EXAMPLES

The effects of the present invention will be made clearer by the following examples. The present invention is not limited to the following examples, and modifications can be made as appropriate without departing from the gist thereof.

### Calculation of Fullerene Content

In the following Examples 1 to 7 and Comparative Example 1, contents of C₆₀ and C₇₀ (fullerene contents) contained in the recovered soot-like material were measured in the following manner in accordance with “JIS Z 8981.”

Specifically, 15 g of 1,2,3,5-tetramethylbenzene (TMB) was added to 0.05 g of the recovered soot-like material, and the mixture was subjected to ultrasonic treatment for 15 minutes to obtain a suspension. The obtained suspension was filtered through a membrane filter having a pore size of 0.5 μm, and the filtrate (the sample liquid) was analyzed by high performance liquid chromatography (HPLC) to quantify C₆₀ and C₇₀, and the contents [% by mass] of C₆₀ and C₇₀ contained in the soot-like material were calculated.

Here, when calculating the contents of C₆₀ and C₇₀ contained in the soot-like material, a calibration curve prepared in advance using a plurality of TMB solutions of C₆₀ and C₇₀ having known concentrations was used.

The HPLC measurement conditions are as follows.
Instrument: Infinity 1260 (manufactured by Agilent)
Amount of sample solution injected: 5 μL
Eluent: toluene (47% by volume)/methanol (53% by volume) mixed solvent
Flow rate of eluent: 1 ml/min
Column: YMC-Pack ODS-AM 100×4.6 mmID S-3 μm, 12 nm
Measurement temperature: 40° C.
Detector: UV 325 nm (JIS)

### Example 1

A fullerene was produced using the fullerene production apparatus 1 shown in FIG. 1. The reaction furnace 2 has features similar to the structure shown in FIG. 2, unless otherwise explained below.

As the reaction furnace 2, a furnace made of alumina which had a length of 1000 mm and an inner radius D of 60 mm and was disposed such that a length direction was the vertical direction was used. The entire outer surface of the reaction furnace 2 was provided with a layer made of alumina as a heat insulating layer.

For the first injection port portion 23c of the burner 9, a cylindrical porous ceramic sintered body having a length of 60 mm and a radius d₃ of 40 mm was used. The distal end surface of this ceramic sintered body is provided with 60 to 80 first injection ports 21a per 1 cm², each of which is substantially circular in a plan view and has a diameter of 0.1 mm to 1.5 mm. The ratio of the radius d₃ of the first injection port portion 23c to the inner radius D of the reaction furnace 2, that is, d₃/D, is 0.67.

For the gas introduction part 10, a structure having the second injection part 25a which was almost similar to the structure shown in FIGS. 2 and 3 was used. The distal end of the second injection part 25a is located 1 cm upstream from the distal end of the first injection port portion 23c in the direction from the side of the upper wall portion 2b (the upstream end side) toward the side of the lower wall portion 2c (the downstream end side).

The second injection part 25a has the cylindrical second injection port portion 25b made of a ceramic sintered body and an alumina layer made of alumina which has a thickness of 2 mm and covers the side surface of the inner circumference of the second injection port portion 25b (a cylindrical inner wall made of alumina). That is, the second injection port portion 25b is sandwiched between the inner surface of the side wall 2a of the cylindrical reaction furnace and the cylindrical inner wall. The distal end surface (a gas ejection portion) of the second injection port portion 25b is ring-shaped in a plan view, with an inner radius of 50 mm and a radial dimension (a thickness) d₁ of 10 mm.

The ratio of the radial dimension (the thickness) d₁ of the distal end surface of the second injection port portion 25b to the inner radius D of the reaction furnace 2, that is, d₁/D, is 0.17. The ratio of the radial distance d₂ between the outer circumference of the distal end surface of the second injection port portion 25b and the side wall 2a of the reaction furnace 2 to the inner radius D of the reaction furnace 2, that is, d₂/D, is 0.00. In other words, the second injection port portion 25b is in direct contact with the side wall 2a. The radial distance d₄ between the inner circumference of the distal end surface of the second injection port portion 25b and the first injection port portion 23c is 10 mm, and the ratio of the radial distance to the inner radius D of the reaction furnace 2, that is, d₄/D, is 0.17.

The distal end surface of the second injection port portion 25b is provided with 60 to 80 second injection ports 22a per 1 cm², each of which is substantially circular in a plan view and has a diameter of 0.1 mm to 1.5 mm. The ratio of the total opening area of the second injection ports 22a to the area of the distal end surface of the second injection port portion 25b is 87%.

A camera was installed in the vicinity of the exhaust gas discharging port 30d in the reaction furnace 2, and the fullerene was produced while photographing the inside of the reaction furnace 2 with the camera.

As the flow meter 35a, a mass flow controller (Aera SFC 168, manufactured by Hitachi Metals) was used, and as the flow meter 35b and the flow meter 36, a mass flow controller (Aera FC-7810 CD, manufactured by Hitachi Metals) was used.

### Fullerene Generation Step

Toluene as the source material gas, which was vaporized by a heating device (not shown), was supplied into the reaction furnace 2 through the pipe 24a via the first injection port portion 23c of the burner 9, and oxygen gas (purity 99.9% by volume) as the first oxygen-containing gas was supplied into the burner 9 through the pipe 24b, and thereby supplied into the reaction furnace 2 (injection I). The source material gas was ignited by the ignition mechanism 31 and incompletely combusted to start the generation of the soot-like material containing a fullerene. At the same time, air as the second oxygen-containing gas was supplied to the gas introduction part 10 through the pipe 26, and thereby supplied into the reaction furnace 2 (injection II).

In the fullerene generation step, the pressure inside the reaction furnace 2 was 5.33 kPa. The flow rate of the toluene to be supplied into the reaction furnace 2 was 38.0 g/min, the flow rate of the first oxygen-containing gas was 26.0 NL/min, and the flow rate of the second oxygen-containing gas was 24.0 NL/min (the flow rate of the second oxygen-containing gas was 0.69 NL/min per 1 cm² of the area of the distal end surface of the second injection port portion 25b). Toluene, the first oxygen-containing gas, and the second oxygen-containing gas were continuously injected into the reaction furnace 2 from the first injection port portion 23c and the second injection port portion 25b of the second injection part 25a, and the incomplete combustion was continued for 3 hours. The temperature inside the reaction furnace 2 was 1500° C.

In Example 1, it was confirmed with the camera that the fullerene production apparatus 1 was operated continuously without the flame being extinguished in the fullerene generation step.

In addition, after that, the operation of the fullerene production apparatus 1 was stopped. After the temperature inside the reaction furnace 2 was returned to room temperature, the burner 9 was removed, and the condition inside the reaction furnace 2 was visually checked. As a result, in the reaction furnace 2, there was little soot-like material adhering to the side wall 2a, and no clogging of the flow channel due to the adhered soot-like material was observed.

In addition, in Example 1, the soot-like material collected in the collector 12 was recovered. The mass of the recovered soot-like material was 520 g.

The content and amount of the fullerene in the soot-like material were determined by the method shown in [Calculation of fullerene content]. As a result, the content of the fullerene was 21% by mass, and the amount of the fullerene was 109 g.

### Example 2

In Example 2, evaluation was performed under the same conditions as in Example 1, except as will be described below.

As the gas introduction part 10, a gas introduction part having a structure which was almost similar to the second injection part 25a shown in FIGS. 4 and 5 was used. The second injection port portion 25b is a slit (a cylindrical opening), which is provided between a cylinder (an inner wall) made of alumina and having a thickness of 3 mm and the inner surface of the side wall 2a. The distal end surface of the second injection port portion 25b has a ring shape in a plan view (the second injection port 22a). The inner circumference radius of the distal end surface of the second injection port portion 25b is 55 mm, and the radial dimension (the thickness) d₁ is 5 mm.

The ratio of the radial dimension (the thickness) d₁ of the second injection port portion 25b to the inner radius D of the reaction furnace 2, that is, d₁/D, is 0.08. The ratio of the radial distance d₂ between the outer circumference of the distal end surface of the second injection port portion 25b and the side wall 2a of the reaction furnace 2 to the inner radius D of the reaction furnace 2, that is, d₂/D, is 0.00. The radial distance d₄ between the inner circumference of the distal end surface of the second injection port portion 25b and the first injection port portion 23c is 15 mm, and the ratio of the radial distance to the inner radius D of the reaction furnace 2, that is, d₄/D, is 0.25.

The flow rate of the second oxygen-containing gas was 24.0 NL/min (the flow rate of the second oxygen-containing gas was 1.33 NL/min per 1 cm² of the area of the distal end surface of the second injection port portion 25b). Except for the above, a fullerene was generated in the same manner as in Example 1.

In Example 2, the fullerene production apparatus 1 could be operated continuously without the flame being extinguished in the fullerene generation step.

In addition, after that, the operation of the fullerene production apparatus 1 was stopped. After the temperature inside the reaction furnace 2 was returned to room temperature, the burner 9 was removed, and the condition inside the reaction furnace 2 was visually checked. As a result, in the reaction furnace 2, there was little soot-like material adhering to the side wall 2a, and no clogging of the flow channel due to the adhered soot-like material was observed.

In addition, in Example 2, the soot-like material collected in the collector 12 was recovered. The mass of the recovered soot-like material was 548 g.

The content and amount of the fullerene in the soot-like material were determined in the same manner as in Example 1. As a result, the content of the fullerene was 16% by mass, and the amount of the fullerene was 88 g.

### Example 3

A fullerene was generated in the same manner as in Example 1, except that the flow rate of the second oxygen-containing gas was 12.0 NL/min (the flow rate of the second oxygen-containing gas was 0.35 NL/min per 1 cm² of the area of the distal end surface of the second injection port portion 25b).

In Example 3, the fullerene production apparatus 1 could be operated continuously without the flame being extinguished in the fullerene generation step.

In addition, after that, the operation of the fullerene production apparatus 1 was stopped. After the temperature inside the reaction furnace 2 was returned to room temperature, the burner 9 was removed, and the condition inside the reaction furnace 2 was visually checked. As a result, in the reaction furnace 2, there was little soot-like material adhering to the side wall 2a, and no clogging of the flow channel due to the adhered soot-like material was observed.

In addition, in Example 3, the soot-like material collected in the collector 12 was recovered. The mass of the recovered soot-like material was 609 g.

The content and amount of the fullerene in the soot-like material were determined in the same manner as in Example 1. As a result, the content of the fullerene was 19% by mass, and the amount of the fullerene was 116 g.

### Example 4

A fullerene was generated in the same manner as in Example 1, except that the second oxygen-containing gas was oxygen gas (purity 99.9% by volume) and the flow rate of the second oxygen-containing gas was 8.0 NL/min (the flow rate of the second oxygen-containing gas was 0.23 NL/min per 1 cm² of the area of the distal end surface of the second injection port portion 25b).

In Example 4, the fullerene production apparatus 1 could be operated continuously without the flame being extinguished in the fullerene generation step.

In addition, after that, the operation of the fullerene production apparatus 1 was stopped. After the temperature inside the reaction furnace 2 was returned to room temperature, the burner 9 was removed, and the condition inside the reaction furnace 2 was visually checked. As a result, in the reaction furnace 2, there was little soot-like material adhering to the side wall 2a, and no clogging of the flow channel due to the adhered soot-like material was observed.

In addition, in Example 4, the soot-like material collected in the collector 12 was recovered. The mass of the recovered soot-like material was 498 g.

The content and amount of the fullerene in the soot-like material were determined in the same manner as in Example 1. As a result, the content of the fullerene was 23% by mass, and the amount of the fullerene was 114 g.

### Example 5

A fullerene was generated in the same manner as in Example 1, except that the second oxygen-containing gas was nitrogen gas (purity 99.9% by volume) and the flow rate of the second oxygen-containing gas was 24.0 NL/min (the flow rate of the nitrogen gas was 0.69 NL/min per 1 cm² of the area of the distal end surface of the second injection port portion 25b).

In Example 5, the fullerene production apparatus 1 could be operated continuously without the flame being extinguished in the fullerene generation step.

In addition, after that, the operation of the fullerene production apparatus 1 was stopped. After the temperature inside the reaction furnace 2 was returned to room temperature, the burner 9 was removed, and the condition inside the reaction furnace 2 was visually checked. As a result, in the reaction furnace 2, there was little soot-like material adhering to the side wall 2a, and no clogging of the flow channel due to the adhered soot-like material was observed.

In addition, in Example 5, the soot-like material collected in the collector 12 was recovered. The mass of the recovered soot-like material was 645 g.

The content and amount of the fullerene in the soot-like material were determined in the same manner as in Example 1. As a result, the content of the fullerene was 13% by mass, and the amount of the fullerene was 84 g.

### Example 6

A fullerene was generated using the fullerene production apparatus 1 shown in FIG. 6. The cylindrical porous body 28 is disposed until 30 mm downstream from the distal end surface of the second injection port portion 25b (20 mm downstream from the distal end surface of the first injection port portion 23c). The radius of the porous body 28 is 60 mm. Except for the above, the structure of the fullerene production apparatus 1 of Example 6 is the same as that of the fullerene production apparatus 1 used in Example 1. The porous body 28 is made of a ceramic sintered body similar to the first injection port portion 23c of Example 1.

As in Example 1, a fullerenes was generated, and the content of the fullerene was measured. In Example 6, the fullerene production apparatus 1 could be operated continuously without the flame being extinguished in the fullerene generation step.

In addition, after that, the operation of the fullerene production apparatus 1 was stopped. After the temperature inside the reaction furnace 2 was returned to room temperature, the burner 9, the gas introduction part 10, and the porous body 28 were removed, and the condition inside the reaction furnace 2 was visually checked. As a result, in the reaction furnace 2, there was little soot-like material adhering to the side wall 2a, and no clogging of the flow channel due to the adhered soot-like material was observed.

In addition, in Example 6, the soot-like material collected in the collector 12 was recovered. The mass of the recovered soot-like material was 532 g.

The content and amount of the fullerene in the soot-like material were determined in the same manner as in Example 1. As a result, the content of the fullerene was 23% by mass, and the amount of the fullerene was 122 g.

### Example 7

In Example 7, injection I was followed by injection II, which was repeated a plurality of times.

### Fullerene Generation Step

The same apparatus as in Example 1 was used. Toluene as the source material gas vaporized by a heating device (not shown) was supplied into the reaction furnace 2 through the pipe 24a via the first injection port portion 23c of the burner 9, and oxygen gas (purity 99.9% by volume) as the first oxygen-containing gas was supplied into the burner 9 through the pipe 24b, and thereby supplied into the reaction furnace 2. The source material gas was ignited by the ignition mechanism 31 and incompletely combusted to start the generation of the soot-like material containing a fullerene. When the generation of these were performed, gas injection from the second injection port portion 25b (injection II) was not performed.

The feed rate of the toluene to be supplied into the reaction furnace 2 was 38.0 g/min, the feed rate of the first oxygen-containing gas was 26.0 NL/min, and a mixed gas of the toluene and the oxygen gas was continuously injected into the reaction furnace 2, and incomplete combustion was continued for 30 minutes.

### Soot-Like Material Removal Step

Thereafter, the supply of the toluene and the first oxygen-containing gas was stopped. After stopping, the soot-like material removal step was performed using the second injection part 25a. Specifically, the flow rate of the nitrogen gas as the inert gas was 30.0 NL/min (the flow rate of an active gas was 0.87 NL/min per 1 cm² of the area of the distal end surface of the second injection port portion 25b), and the nitrogen gas was injected into the reaction furnace 2 from the second injection port portion 25b of the second injection part 25a for 10 seconds.

The fullerene generation step and the soot-like material removal step described above were alternately repeated five times. After that, the operation of the fullerene production apparatus 1 was stopped. After the temperature inside the reaction furnace 2 was returned to room temperature, the burner 9 was removed, and the condition inside the reaction furnace 2 was visually checked. As a result, in the reaction furnace 2, there was little soot-like material adhering to the side wall 2a, and no clogging of the flow channel due to the adhered soot-like material was observed.

In addition, in Example 7, the soot-like material collected in the collector 12 was recovered. The mass of the recovered soot-like material was 668 g.

The content and amount of the fullerene in the soot-like material were determined in the same manner as in Example 1. As a result, the content of the fullerene was 14% by mass, and the amount of the fullerene was 94 g.

### Comparative Example 1

A fullerene production apparatus used in Comparative Example 1 is the same as the fullerene production apparatus 1 used in Example 1, except that it does not have the gas introduction part 10. That is, injection II was not performed.

Toluene as the source material gas vaporized by a heating device (not shown) was supplied into the reaction furnace 2 through the pipe 24a via the first injection port portion 23c of the burner 9, and oxygen gas (purity 99.9% by volume) as the first oxygen-containing gas was supplied into the burner 9 through the pipe 24b, and thereby supplied into the reaction furnace 2. The source material gas was ignited by the ignition mechanism 31 and incompletely combusted to start the generation of the soot-like material containing a fullerene. No gas was supplied through the pipe 26. The pressure inside the reaction furnace 2 was 5.33 kPa. The flow rate of the toluene to be supplied into the reaction furnace 2 was 38.0 g/min, and the feed rate of the first oxygen-containing gas that was supplied into the reaction furnace 2 was 26.0 NL/min.

As a result, in 45 minutes after the start of the fullerene production step, the flashback prevention device was activated and the operation of the fullerene production apparatus was stopped.

In Comparative Example 1, after that, the operation of the fullerene production apparatus was stopped. After the temperature inside the reaction furnace 2 was returned to room temperature, the burner 9 was removed, and the condition inside the reaction furnace 2 was visually checked. As a result, in the reaction furnace 2, clogging of the flow channel due to the soot-like material adhering to the side wall 2a was observed.

In addition, in Comparative Example 1, the soot-like material collected in the collector 12 was recovered. The mass of the recovered soot-like material was 214 g.

The content and amount of the fullerene in the soot-like material were determined in the same manner as in Example 1. As a result, the content of the fullerene was 12% by mass, and the amount of the fullerene was 29 g.

In Examples 1 to 7, compared with Comparative Example 1, no large amount of the soot-like material that has adhered to the side wall 2a was observed and no clogging of the flow channel due to the adhered soot-like material was observed. It was confirmed that the operation could be performed for a long period of time and a fullerene was efficiently produced by using the fullerene production apparatus 1 of the present invention.

### INDUSTRIAL APPLICABILITY

The present invention can provide a fullerene production apparatus that can improve fullerene production efficiency.

### REFERENCE SIGNS LIST

1 Fullerene production apparatus
2 Reaction furnace
2a Side wall of reaction furnace
2b Upper wall portion of reaction furnace
2c Lower wall portion of reaction furnace
3 Recovery mechanism
4 Cooling mechanism
5 Pressure reduction mechanism (vacuum pump)
6 First pipe
7 Second pipe
8 Third pipe
9 First injection part (burner)
10 Gas introduction part
11 Filter
12 Collector
13 Electromagnetic valve
14 Tank
15 Discharge valve
16 Drain
21a First injection port
22a Second injection port
23 Burner holder
23a Premixing chamber
23b Pressure accumulation chamber
23c First injection port portion
24a Pipe
24b Pipe
25a Second injection part
25b Second injection port portion
26 Pipe
27 Connection pipe
28 Porous body
30d Exhaust gas discharging port
31 Ignition mechanism
35a Flow meter
35b Flow meter
36 Flow meter
D Inner radius of reaction furnace
d1 Radial thickness dimension
d2 Radial distance
d3 Radius of injection port
d4 Radial distance

1. An apparatus for producing a fullerene, comprising:
a reaction furnace in which a fullerene is generated by incomplete combustion of a source material gas containing a hydrocarbon;
a first injection part which is disposed on an upstream end side of the reaction furnace and causes the source material gas to incompletely combust in the reaction furnace by injecting the source material gas and a first oxygen-containing gas toward a downstream end side of the reaction furnace; and
a second injection part which is disposed on the upstream end side of the reaction furnace to surround the first injection part and injects a second oxygen-containing gas or an inert gas toward the downstream end side of the reaction furnace along a side wall of the reaction furnace which is located between the upstream end side and the downstream end side.

2. The apparatus for producing a fullerene according to claim 1, wherein, when the reaction furnace is viewed in a vertical cross section in a direction from the upstream end side toward the downstream end side,
a distal end of the second injection part is located in the same cross section of the reaction furnace as a distal end of the first injection part, or
the distal end of the second injection part is located upstream from the distal end of the first injection part.

3. The apparatus for producing a fullerene according to claim 2,
wherein a side wall of the reaction furnace is cylindrical,
the second injection part has a second injection port portion of which a distal end surface has a ring shape, and
when a radial thickness dimension of the distal end surface of the second injection port portion is d₁ and an inner radius of the reaction furnace is D, d₁/D is 0.01 to 0.40.

4. The apparatus for producing a fullerene according to claim 3, wherein, when a radial distance between an outer circumference of the distal end surface of the second injection port portion and an inner side of the side wall of the reaction furnace is d₂, d₂/D is 0.00 to 0.10.

5. The apparatus for producing a fullerene according to claim 3, wherein the first injection part has a cylindrical first injection port portion, a distal end surface of the first injection port portion is provided with a first injection port, and when a radius of the first injection port portion is d₃, d₃/D is 0.40 to 0.96.

6. The apparatus for producing a fullerene according to claim 5, wherein, when a radial distance between an outer circumference of the first injection port portion and an inner circumference of the distal end surface of the second injection port portion is d₄, d₄/D is 0.01 to 0.25.

7. The apparatus for producing a fullerene according to claim 3,
wherein the distal end surface having a ring shape of the second injection port portion is provided with a plurality of second injection ports, each of which has a diameter of 0.1 mm to 5.0 mm,
the second injection ports are uniformly disposed on the distal end surface of the second injection port portion, and
a ratio of the total opening area of the second injection ports to an area of the distal end surface of the second injection port portion is 10% to 95%.

8. The apparatus for producing a fullerene according to claim 3, wherein the second injection port portion is made of a porous body.

9. The apparatus for producing a fullerene according to claim 3, wherein a second injection port of the second injection port portion is a ring-shaped slit in a plan view.

10. The apparatus for producing a fullerene according to claim 3, wherein a flow rate of the second oxygen-containing gas or the inert gas which is injected from the second injection part is 0.1 to 10.0 NL/min per 1 cm² of an area of the distal end surface of the second injection port portion.

11. The apparatus for producing a fullerene according to claim 1,
wherein the upstream end side of the reaction furnace is provided with a cylindrical porous body to cover or bury a distal end of the first injection part and a distal end of the second injection part, and
in a direction from the upstream end side toward the downstream end side, a thickness of the porous body from the distal end located on a downstream side of each of the first injection part and the second injection part to a distal end located on a downstream side of the cylindrical porous body is 1 to 50 mm.

12. A method for producing a fullerene, comprising
a fullerene generation step of generating soot-like material containing a fullerene in a reaction furnace by incomplete combustion of a source material gas containing a hydrocarbon,
wherein, in the fullerene generation step,
while the source material gas and a first oxygen-containing gas are injected from a first injection part disposed at an upstream end side of the reaction furnace toward a downstream end side thereof, the source material gas is incompletely combusted in the reaction furnace, and
a second oxygen-containing gas or an inert gas is injected from a second injection part, which is disposed at the upstream end side to surround the first injection part, toward the downstream end side along a side wall of the reaction furnace which is located between the upstream end side and the downstream end side.

13. A method for producing a fullerene, comprising:
a fullerene generation step in which, while a source material gas containing a hydrocarbon and a first oxygen-containing gas are injected from a first injection part, which is disposed at an upstream end side of a reaction furnace, toward a downstream end side thereof, the source material gas is incompletely combusted to generate soot-like material containing a fullerene; and
a soot-like material removal step in which, after the fullerene generation step, a second oxygen-containing gas or an inert gas is injected from a second injection part, which is disposed at the upstream end side of the reaction furnace to surround the first injection part, toward the downstream end side along a side wall of the reaction furnace, which is located between the upstream end side and the downstream end side, to remove the soot-like material that has adhered to the side wall of the reaction furnace.
